(19) United States
(12) Patent Application Publication
(10) Pub. No.: US 2020/0313252 A1
(43) Pub. Date: Oct. 1, 2020

(54) COOLING SYSTEM FOR BATTERY OF VEHICLE

(71) Applicants: Hyundai Motor Company, Seoul (KR); Kia Motors Corporation, Seoul (KR)

(72) Inventors: Jin Won Kim, Pyeongtaek-si (KR); Jun Seok Choi, Hwaseong-si (KR)

(73) Assignees: Hyundai Motor Company, Seoul (KR); Kia Motors Corporation, Seoul (KR)

(21) Appl. No.: 16/661,943

(22) Filed: Oct. 23, 2019

(30) Foreign Application Priority Data
Mar. 27, 2019 (KR) 10-2019-0034918

(51) Int. Cl. H01M 10/613; H01M 10/625; H01M 10/6556; H01M 10/6568; B60L 58/26; B60L 50/64; B60L 58/12

(52) U.S. Cl. CPC H01M 10/613; H01M 10/625; H01M 10/6556; H01M 10/6568; B60L 2240/547; B60L 50/64; B60L 58/12; H01M 2220/20; B60L 2240/545; B60L 58/26

(57) ABSTRACT

A cooling system for a battery of a vehicle may include a plurality of battery cell pouches each having wings formed at both end portions thereof and stacked in parallel with each other, one or more of the wings being unfolded, an intermediate housing mounted between the plurality of battery cell pouches and fixing the plurality of battery cell pouches, and a cooling channel unit formed on at least one of upper and lower end portions of the plurality of battery cell pouches, having a flow channel through which a refrigerant flows therein and into which the wings of the plurality of battery cell pouches are partially exposed.

### CROSS REFERENCE TO RELATED APPLICATION

The present application claims priority to Korean Patent Application No. 10-2019-0034918, filed on Mar. 27, 2019, the entire contents of which is incorporated herein for all purposes by this reference.

### BACKGROUND OF THE INVENTION

### Field of the Invention

The present invention relates to a cooling system for a battery of a vehicle, and more particularly, to a cooling system for a battery of a vehicle which may cool a battery cell by directly cooling a wing of a battery cell pouch without folding the wing of a battery cell pouch.

### Description of Related Art

In accordance with popularization of an electric vehicle or a hybrid vehicle, interest in importance of a battery has gradually increased. This interest has been expanded to a factor of the battery having an effect on efficiency, a lifespan, or the like as well as a capacity of the battery.

A high voltage and high capacity battery used in the electric vehicle or the hybrid vehicle is a battery pack in which a plurality of battery cells are included in a single pack, and a plurality of such battery packs are included in an entire battery.

The plurality of battery packs are installed together in a limited and narrow space, such that high heat is generated in the battery packs, which acts as a factor having a negative effect on a lifespan of the entire battery. Therefore, it is essential to construct a cooling system for controlling the high heat of the high voltage and high capacity battery used in the electric vehicle or the hybrid vehicle. In general, a cooling system for the high voltage and high capacity battery of a vehicle is classified into an air cooling system and a water cooling system, each of which is classified again into an indirect cooling system and a direct cooling system.

Meanwhile, in a conventional indirect air cooling system, a separate heat radiating plate is brought into contact with a surface of the battery cell to conduct heat, and the battery cell is cooled through a heat radiating fin positioned on a side of the heat radiating plate for heat exchange. Furthermore, in a conventional direct air cooling system, the battery cell is cooled by air directly flowing to the surface of the battery cell.

However, the conventional indirect air cooling system has a limitation in that the heat radiating fin is required between the battery cells and thus the cost increases due to more components and greater volume of the battery. The direct air cooling system has a limitation in that a gap for a cooling channel is required between the battery cells and thus the battery has greater volume.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a cooling system for a battery of a vehicle which may cool a battery cell without forming a cooling channel between battery cells and without a heat radiating fin and a heat radiating plate.

According to an exemplary embodiment of the present invention, a cooling system for a battery of a vehicle may include a plurality of battery cell pouches each having wings formed at both end portions thereof and stacked in parallel with each other, one or more of the wings being unfolded, an intermediate housing mounted between the plurality of battery cell pouches and fixing the battery cell pouches, and a cooling channel unit formed on at least one of upper and lower end portions of the battery cell pouch, having a flow channel through which a refrigerant flows therein and to which the wing of the battery cell pouch is partially exposed.

The cooling system for a battery of a vehicle may further include: a first side housing mounted on one side of a battery cell pouch positioned at one outermost portion among the stacked battery cell pouches to protect the battery cell pouch; and a second side housing mounted on the other side of a battery cell pouch positioned at the other outermost portion among the stacked battery cell pouches to protect the battery cell pouch.

The cooling system for a battery of a vehicle may further include a sensing unit configured of detecting a state of the battery cell, and a sensing unit cover covering the sensing unit.

The cooling system for a battery of a vehicle may further include a cooling fan allowing the refrigerant to flow into the cooling channel unit to cool the wing of the battery cell pouch, cooling the battery cell.

The cooling channel unit may have hooks to be coupled to the first side housing and the second side housing, respectively, and the first side housing and the second side housing may have protrusions to be coupled to the hooks, respectively.

The battery cell pouch may include a body and wings, and the intermediate housing may have a height higher than the body, such that the wings of the battery cell pouch are fixed by at least one of upper and lower end portions of the intermediate housing.

The cooling system for a battery of a vehicle may further include a heat exchanger inserted between the plurality of battery cell pouches, being brought into a surface-contact with the battery cell pouch, to absorb heat of the battery cell pouch and then to radiate the heat through the wing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a cooling system for a battery of a vehicle according to an exemplary embodiment of the present invention.

FIG. 2 is a view exemplarily illustrating that a cooling channel unit is formed in upper and lower end portions of a battery cell pouch and the upper and lower end portions of the battery cell pouch are cooled in a cooling system for a battery of a vehicle according to an exemplary embodiment of the present invention.

FIG. 3 is a view exemplarily illustrating that a cooling channel unit is formed on both end portions of a battery cell pouch in a cooling system for a battery of a vehicle according to an exemplary embodiment of the present invention.

FIG. 4 is a view exemplarily illustrating that a wing of a battery cell pouch is fixed by an intermediate housing in a cooling system for a battery of a vehicle according to an exemplary embodiment of the present invention.

FIG. 5 is a view exemplarily illustrating that a heat exchanger is inserted between battery cell pouches in a cooling system for a battery of a vehicle according to an exemplary embodiment of the present invention.

FIG. 6 is a view exemplarily illustrating that a hook formed in a cooling channel unit is coupled to a protrusion of a side housing portion in a cooling system for a battery of a vehicle according to an exemplary embodiment of the present invention.

FIG. 7 is a schematic view exemplarily illustrating a procedure for manufacturing a cooling system for a battery of a vehicle according to an exemplary embodiment of the present invention.

FIG. 8 is a view exemplarily illustrating a cooling system for a battery of a vehicle according to various exemplary embodiments of the present invention.

FIG. 9 is a view exemplarily illustrating that a cooling channel unit is formed only on an upper end portion of a battery cell pouch and the upper end portion of the battery cell pouch is cooled in a cooling system for a battery of a vehicle according to various exemplary embodiments of the present invention.

FIG. 10 is a view exemplarily illustrating that a cooling channel unit is formed only on one end portion of a battery cell pouch in a cooling system for a battery of a vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a cooling system for a battery of a vehicle according to exemplary embodiments of the present invention is described with reference to the accompanying drawings.

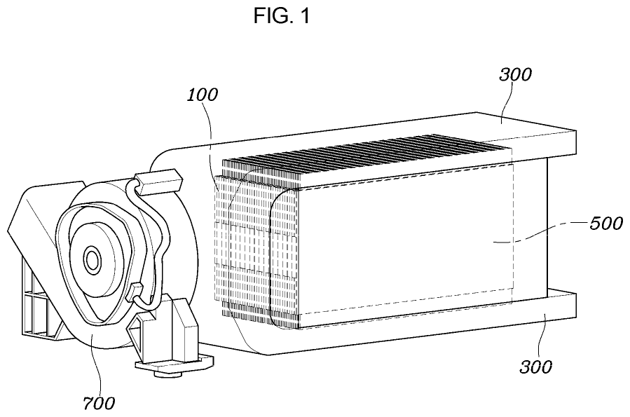

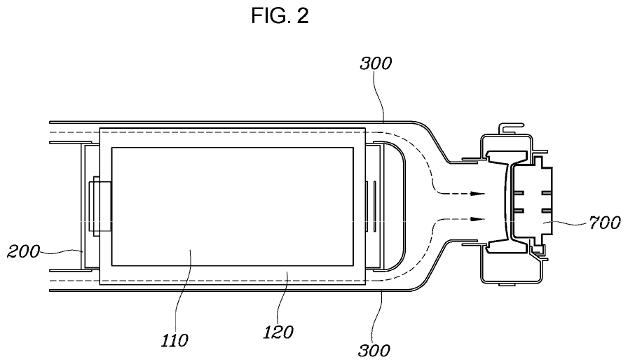

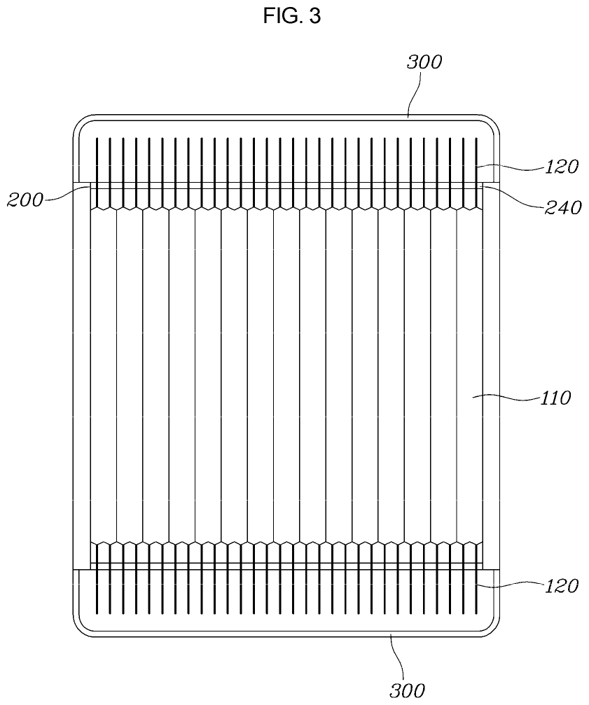

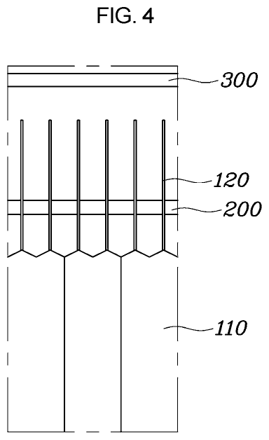

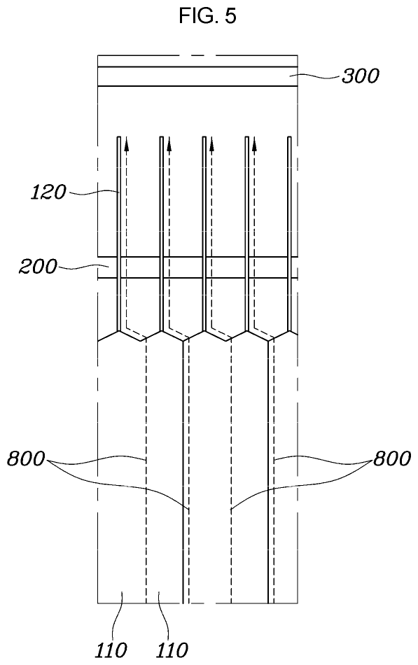

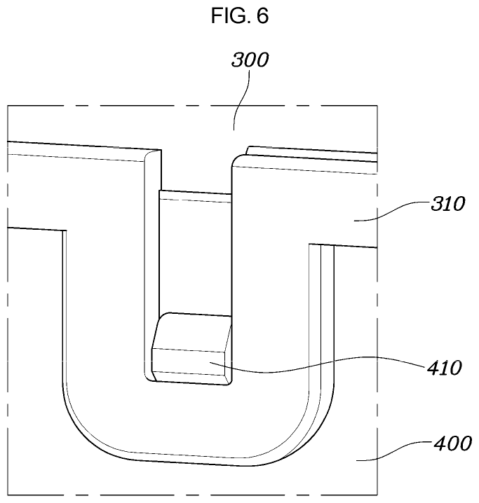

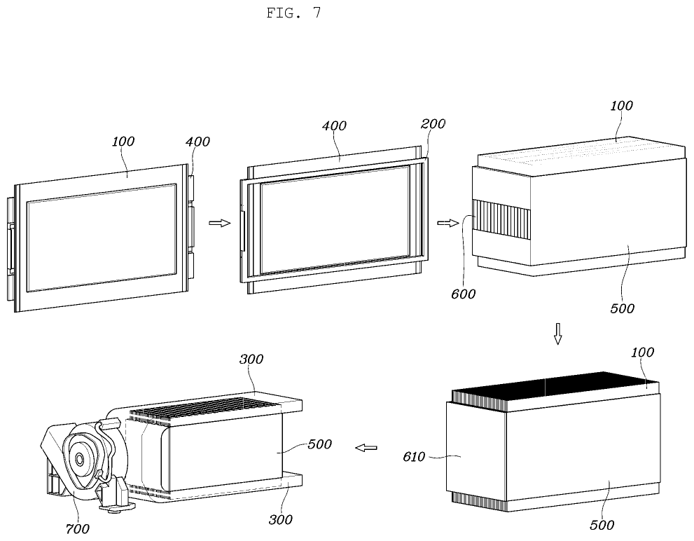

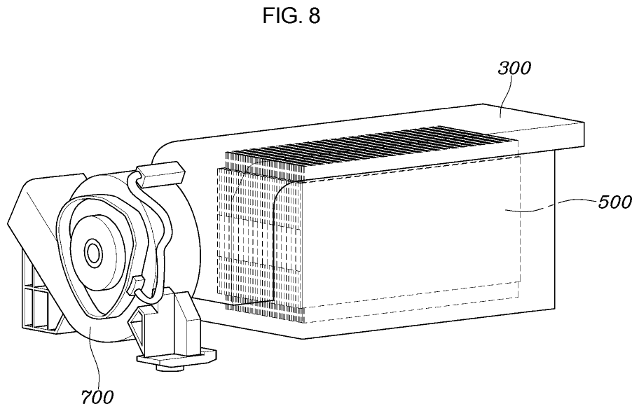

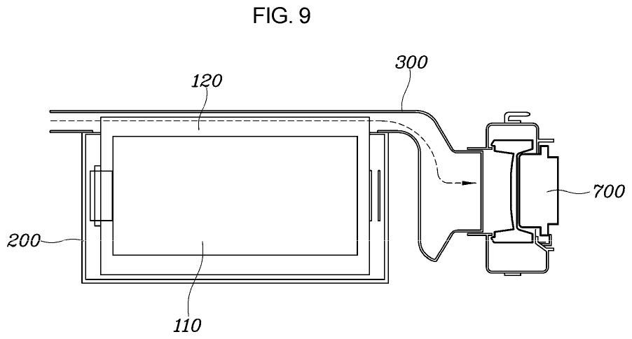

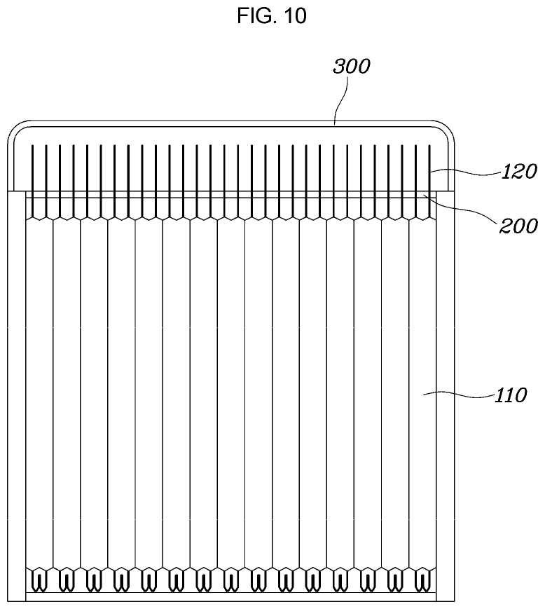

FIG. 1 is a view exemplarily illustrating a cooling system for a battery of a vehicle according to an exemplary embodiment of the present invention; FIG. 2 is a view exemplarily illustrating that a cooling channel unit is formed in upper and lower end portions of a battery cell pouch and the upper and lower end portions of the battery cell pouch are cooled in a cooling system for a battery of a vehicle according to an exemplary embodiment of the present invention; FIG. 3 is a view exemplarily illustrating that a cooling channel unit is formed on both end portions of a battery cell pouch in a cooling system for a battery of a vehicle according to an exemplary embodiment of the present invention; FIG. 4 is a view exemplarily illustrating that a wing of a battery cell pouch is fixed by an intermediate housing; FIG. 5 is a view exemplarily illustrating that a heat exchanger is inserted between battery cell pouches; FIG. 6 is a view exemplarily illustrating that a hook formed in a cooling channel unit is coupled to a protrusion of a side housing portion; FIG. 7 is a schematic view exemplarily illustrating a procedure for manufacturing a cooling system for a battery of a vehicle according to an exemplary embodiment of the present invention; FIG. 8 is a view exemplarily illustrating a cooling system for a battery of a vehicle according to various exemplary embodiments of the present invention; FIG. 9 is a view exemplarily illustrating that a cooling channel unit is formed only on an upper end portion of a battery cell pouch and the upper end portion of the battery cell pouch is cooled in a cooling system for a battery of a vehicle according to various exemplary embodiments of the present invention; and FIG. 10 is a view exemplarily illustrating that a cooling channel unit is formed only on one end portion of a battery cell pouch in a cooling system for a battery of a vehicle according to various exemplary embodiments of the present invention.

Referring to FIG. 1, FIG. 2, and FIG. 3, a cooling system for a battery of a vehicle according to an exemplary embodiment of the present invention may include a plurality of battery cell pouches 100, an intermediate housing 200 and a cooling channel unit 300, and may further include at least one among a first side housing 400, a second side housing 500, a sensing unit 600, a cooling fan 700 and a heat exchanger 800.

In detail, the battery cell pouch 100 may include a body 110 and wings 120 formed on both end portions thereof. Here, the body 110 may be a main portion of the battery cell pouch, and the wings 120 may be formed by unfolding both end portions of the battery cell pouch after sealing the battery cell pouch. The battery cell pouches 100 may be stacked in parallel with each other and one or more of the wings 120 formed on both the end portions of the battery cell pouch may be unfolded. According to an exemplary embodiment of the present invention, as illustrated in FIG. 2, the wings 120 formed on both the end portions of the battery cell pouch 100 may be unfolded. Alternatively, according to another exemplary embodiment of the present invention, as illustrated in FIG. 10, of the wings 120 formed on both the end portions of the battery cell pouch 100, the wing 120 formed on a lower end portion of the battery cell pouch 100 may be folded and the wing 120 formed on an upper end portion of the battery cell pouch 100 may be unfolded. Here, whether the wings 120 formed on both the end portions of the battery cell pouch 100 are folded or unfolded may depend on whether both upper and lower end portions of the battery cell pouch 100 are to be cooled or only one of the upper and lower end portions of the battery cell pouch 100 is to be cooled.

For example, as illustrated in FIG. 2, in a cooling system for a battery which cools both the upper and lower end portions of the battery cell pouch 100, the wings 120 formed on both the end portions of the battery cell pouch 100 may be unfolded. Whereas, as illustrated in FIG. 10, in a cooling system for a battery which cools only the upper end portion of the battery cell pouch 100, only the wing 120 formed on the upper end portion of the battery cell pouch 100 may be unfolded.

The intermediate housing 200 may be mounted between the plurality of battery cell pouches 100 and serve to fix the battery cell pouches 100. In detail, referring to FIG. 7, the intermediate housing 200 may have a square plate shape at a center portion of which an open hole 240 is formed, and the center portion of the intermediate housing 200, where the open hole is formed, may be fitted to and mounted on the body 110 where the main portion of the battery cell pouch 100 is formed. Here, the intermediate housing 200 may have a height higher than the body 110, such that the wings 120 may be fixed by at least one of upper and lower end portions 210 and 220 of the intermediate housing. In more detail, referring to FIGS. 4 and 10, when the intermediate housing 200 is mounted on the battery cell pouch 100, the upper end portion 210 of the intermediate housing 200 is brought into close contact with the wing 120 so that the wing 120 is maintained in a straight shape without being bent. Therefore, a surface area in contact with a refrigerant flowing into the cooling channel unit 300 may be maximized, and as a result, cooling performance of the battery cell may be improved.

The cooling channel unit 300 may be formed on at least one of the upper and lower end portions of the battery cell pouch 100, a flow channel through which the refrigerant flows is formed in the cooling channel unit 300, and the wing 120 of the battery cell pouch 100 may be partially exposed to the flow channel. In an exemplary embodiment of the present invention, without a heat radiating fin and a heat radiating plate used in a conventional indirect air cooling system, the both end portions of the battery cell pouch 100 are unfolded to form the wings 120 and the wings 120 are partially exposed to the cooling channel unit 300; and accordingly, as the refrigerant flows into the cooling channel unit 300, the wings 120 are cooled to cool the battery cell pouch. Accordingly, it is not necessary to form a separate cooling channel between the battery cell pouches, and material cost for the heat radiating plate and the heat radiating fin may be saved. Furthermore, the wing of the battery cell pouch may be unfolded and thus, a process of folding the wing may be removed, saving the material cost.

Meanwhile, the cooling channel unit 300 may have hooks 310 to be coupled to the first side housing 400 and the second side housing 500, respectively. Furthermore, the first side housing 400 and the second side housing 500 may have protrusions 410 and 510 to be coupled to the hooks 310, respectively. According to an exemplary embodiment of the present invention, as illustrated in FIG. 6, the hook 310 formed on the cooling channel unit 300 may be coupled to the protrusion 410 formed on the first side housing 400 in a clip coupling manner.

Meanwhile, as illustrated in FIG. 5, the present invention may further include the heat exchanger 800 which is inserted between the plurality of battery cell pouches, being brought into a surface-contact with the battery cell pouch 100, to absorb heat of the battery cell pouch 100 and then to radiate the heat through the wing 120. Here, the heat exchanger 800 may be formed of a material having excellent thermal conductivity. That is, the heat exchanger 800 having excellent thermal conductivity may be inserted between the battery cell pouches 100 and may radiate heat generated from the battery cell pouch 100 through the wing 120 more efficiently, such that the cooling performance of the battery cell pouch 100 may be improved.

Referring to FIG. 7, the first side housing 400 may be mounted on one side of a battery cell pouch 100 positioned at one outermost portion among the stacked battery cell pouches 100 to protect the battery cell pouch 100 from a foreign material or the like. Furthermore, the second side housing 500 is mounted on the other side of a battery cell pouch 100 positioned at the other outermost portion among the stacked battery cell pouches 100 to protect the battery cell pouch 100 from a foreign material or the like.

The sensing unit 600 is configured to detect a state of the battery cell and a sensing unit cover 610 is configured to protect a terminal of the sensing unit 600 and the like. Here, the sensing unit 600 may be a sensor measuring temperature, voltage and state of charge (SOC) value of the battery.

In an exemplary embodiment of the present invention, the sensing unit 600 is mounted on a surface of the intermediate housing 200 and the sensing unit cover 610 is mounted on a portion of the intermediate housing 200 to cover the sensing unit 600.

The cooling fan 700 may allow the refrigerant to flow into the cooling channel unit 300 and thus may cool the wing 120 of the battery cell pouch 100, cooling the battery cell. In an exemplary embodiment of the present invention, air may be the refrigerant in the cooling channel unit 300. In other words, as illustrated in FIGS. 2 and 9, when the cooling fan 700 is driven, the air in the cooling channel unit 300 may flow to cool the wing 120, cooling the battery cell.

In an exemplary embodiment of the present invention, as illustrated in FIG. 2, the cooling channel unit 30 is in a shape of “C” and the cooling fan 700 is mounted in the middle of cooling channel unit 30.

As described above, the cooling system for a battery of a vehicle according to an exemplary embodiment of the present invention does not have the cooling channel formed between the battery cells as in a conventional direct air cooling system; and accordingly, has volume energy density increased by 10% to 20%.

Furthermore, the battery cell may be cooled without the heat radiating fin and the heat radiating plate unlike the conventional indirect air cooling system; and accordingly, the system in an exemplary embodiment of the present invention may save the material cost for the heat radiating plate and the heat radiating fin.

Furthermore, the wing of the battery cell pouch may be unfolded and thus, a process of folding the wing may be eliminated, saving the material cost.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A cooling system for a battery of a vehicle, the cooling system comprising:
a plurality of battery cell pouches each having wings formed at a first end portion and a second end portion thereof and stacked in parallel with each other, at least one of the wings being unfolded;
an intermediate housing mounted between the plurality of battery cell pouches and fixing the plurality of battery cell pouches; and
a cooling channel unit formed on at least one of upper and lower end portions of the plurality of battery cell pouches, having a flow channel through which a refrigerant flows therein and into which the wings of the plurality of battery cell pouches are partially exposed.

2. The cooling system of claim 1, further including:
a first side housing mounted on a side of a first battery cell pouch positioned at an outermost among the plurality of stacked battery cell pouches to protect the first battery cell pouch; and
a second side housing mounted on a side of a second battery cell pouch positioned at another outermost among the plurality of stacked battery cell pouches to protect the second battery cell pouch.

3. The cooling system of claim 1, further including:
a sensing unit configured of detecting a state of the plurality of battery cell pouches; and
a sensing unit cover covering the sensing unit.

4. The cooling system of claim 3, wherein the sensing unit is mounted on a surface of the intermediate housing and the sensing unit cover is mounted on a portion of the intermediate housing to cover the sensing unit.

5. The cooling system of claim 1, further including a cooling fan connected to the cooling channel unit and allowing the refrigerant to flow into the cooling channel unit to cool the wings of the plurality of battery cell pouches, cooling the plurality of battery cell pouches.

6. The cooling system of claim 2,
wherein the cooling channel unit has hooks to be coupled to the first side housing and the second side housing, respectively; and
the first side housing and the second side housing have protrusions to be coupled to the hooks, respectively.

7. The cooling system of claim 1,
wherein the plurality of battery cell pouches includes a body and the wings; and
wherein the intermediate housing has a height higher than the body, such that the wings are fixed by at least one of upper and lower end portions of the intermediate housing.

8. The cooling system of claim 1,
wherein the plurality of battery cell pouches includes a body and wings; and
wherein the intermediate housing has an open hole at a center portion thereof into which the body of the plurality of battery cell pouches is mounted.

9. The cooling system of claim 1, further including a heat exchanger inserted between the plurality of battery cell pouches and being brought into a contact with the plurality of battery cell pouches, to absorb heat of the plurality of battery cell pouches and then to radiate the heat through the wings.

10. The cooling system of claim 1,
wherein the cooling channel unit includes a first flow channel at the upper end portion of the plurality of battery cell pouches and a second flow channel at the lower portion of the plurality of battery cell pouches, and the refrigerant flows through the first and second flow channels.

11. The cooling system of claim 10, wherein the first flow channel and the second flow channel are formed of “C” shape.

12. The cooling system of claim 11, further including a cooling fan connected to a location in which the first flow channel and the second flow channel are connected.
